(19) United States
(12) Patent Application Publication
(10) Pub. No.: US 2004/0162025 A1
(43) Pub. Date: Aug. 19, 2004

(54) ENHANCED EMBEDDED ELECTRONICS FOR WIRELESS TRANSMISSION AND RECEPTION OF AUDIO IN SUBWOOFER APPLICATIONS

(76) Inventor: Jan Princeton Plummer, Marietta, GA (US)

Correspondence Address: JAN P. PLUMMER, 341 ENGLAND PL NE., MARIETTA, GA, 30066, US

(21) Appl. No.: 10/605,881

(22) Filed: Nov. 3, 2003

Related U.S. Application Data
(60) Provisional application No. 60/423,743, filed on Nov. 5, 2002.

(51) Int. Cl. H04B 7/00

(52) U.S. Cl. 455/41.2; 455/39

(57) ABSTRACT

The subwoofer category of audio component is the newest category for speaker systems. The idea of adding the deeper bass tones using a separate loudspeaker has been around for some time but the category only came to fruition with the promotion of the home theater. The home theater application has made no particular reference to placement of the subwoofer in the living environment but practical implementation says place it wherever it sounds best. The ambiguous acoustic conditions that exist in various locations preclude prediction or conclusions in a timely manner of the best location for placing the subwoofer in a room. If wiring was included as part of a custom installation to place a subwoofer in an environment it may be decided later that it is not the best location. It may be a requirement that an additional unit be located in a place not originally calculated or prepared for. It is only an illusion to be capable of predicting the proper location and numbers of subwoofers to be optimum for a given installation. The locations will however be within the same space occupied by the main speakers making reliable relocation a simple process with a reliable wireless system. It is for this reason that predictable reliable wireless communication of the signal directly from the source via of RF transmission would be ideal as a staple communication for the subwoofer. This application focuses on the development of transmission and reception schemes that allow low power RF transmission already approved by most governments to be reliably embedded into consumer electronic entertainment systems. Focused technology for this application would permit large-scale acceptance of this technique to be included within the host component and subwoofer. Presently there exist thousands of allocated public RF transmission channels that can't be used reliably for any of their proposed usages. Distance from the transmitter both weakens the intended signal level and allows unwanted signals to capture control of the system receiver. Our application of electronic processing to optimize an RF transmission for very low audio frequencies while minimizing maximum transmission distance to within the same general enclosure insures extremely high reliability. The reliable wireless communication of the signal directly from the source via of RF transmission would be ideal as a staple communication for the subwoofer. Specific RF enhancement circuits are not mentioned in this application and are not the subject of any claims.

### BACKGROUND OF INVENTION

The add on subwoofer is a relatively new product for the audio market. Much thought has been given into properly reproducing the low tones but not much thought has been applied to making this add on product easy to introduce into an existing system and physical environment. This is especially true of the consumer environment where a decision to include a subwoofer may not be have been originally considered and it must be easily integrated into the system. It is both desirable and necessary to include the proper low frequency information in the presentation of audio in an acoustic environment if realism and clarity is the goal. The subwoofer was created to allow any sound system to be capable of having very low frequencies. The subwoofer produces sound that is omni-directional and in theory should have an equal sound at all points within a certain radius. Since this product is generally used within the confines of a room structure the walls serve as reflectors for the signal coming from the woofer. It is therefore unpredictable to know in advance a favorable position for the physical location of the subwoofer and in some cases an initial location decision may prove to be undesirable later. Further it may be undesirable to expose wiring and in some cases it is impossible to hide or it may become a safety issue. In many cases it may be desirable to locate several subwoofers within the same room environment to provide the desired effect for the installation. A simple reliable connection method is preferred to allow more flexibility in physically introducing this component to an unknown environment. It is well known to transmit and receive audio frequencies using low power RF transmission schemes full frequency range application of inadequate RF levels invariably leads to marginal performance. Conflicting resources generally exist when attempting to use a low power RF transmission for a high-fidelity (wide bandwidth) performance. Typically it is desired to transfer the sound from one location to another not within the same room. However with exception of low bandwidth very low frequencies signals all full range signals are subject to noticeable interference. The very lowest frequencies are not the focal point for this normal transmission application and for general purpose the lowest frequencies are truncated to prevent over modulation of the full range of frequencies. Typically frequencies below 40 Hz are removed prior to modulation to increase the effective modulation for the full range signal.

### SUMMARY OF INVENTION

This application proposes to dedicate pre and post operations to electrically optimize a low power RF signal for maximum reliability in transmission of very low audio frequencies within the confines of the immediate environment of the full range speakers. It is the object of this invention to substantially permit this method of communication to be the preferred method of connecting this component even above a direct connection to a self-powered subwoofer. FM modulation favors low sub bass frequencies for maximum usage of the allowed deviation over a narrow bandwidth. This allows for an improved signal to noise ratio. FM is also the least costly transmission system available because of its' popularity. It is a further intention of this application to apply this communication method as an embedded function within devices that serve as sources of the full range signal. This could include all manner of devices whose purpose is to provide the final signal to the loudspeakers or at least the main signal. A standard can be established utilizing the simplest and least expensive technologies to accomplish this single one purpose task. This application will describe multiplexing of several narrow band low frequency channels to permit multiple signals to be provided to the different speaker positions of modern multi-channel soundtrack and audio only recordings. This application relates to the integration of subwoofers into modern audio systems both commercial and consumer. In particular this invention relates to using lower power RF wired (carrier current) and wireless transmission and reception schemes to transmit (broadcast) low frequency information to a separate subwoofer system designed to provide low bass to the same acoustical environment as the main speaker. Low RF carrier power transmission of audio signals generally results in a compromised performance open to present and future interference situations. It would normally be considered a low fidelity function in dedicating an entire apparatus to transmitting such a narrow band of frequencies for any purpose. Why would one even seek a patent to express the modulation of typically a noise frequency component in the typically noisy environment of low transmitted RF power?

### BRIEF DESCRIPTION OF DRAWINGS

FIG. 1 is an illustration of a typical connection of the powered subwoofer to the source component delivering the full range or low passed signal to the subwoofer. AC power is also indicated.

FIG. 2 a simple illustration illustrating the use of a single transmitter to provide low pass information to a single or multiple subwoofers.

FIG. 3 a simple illustration of the use of pre and post filtering in transmitting and receiving the low frequency information to enhance the reliability of the subwoofers operation.

FIG. 4 a simple illustration of the inclusion of a transmitter within the source component for the purpose of providing a wireless connection to the subwoofer.

FIG. 5 an illustration of the subwoofer and source communicating by way of carrier current or power line multiplexing providing a single connection to establish power and signal.

FIG. 6 an illustration of the typical signal to noise improvement to be gained with post signal processing only to provide inherent reliability to this low power application of audio frequencies.

FIG. 7 an illustration of the signal connections required to facilitate a typical wireless subwoofer transmitter. This is an external unit intended to be connected to the source component internally. This embedded transmitter would sample the signals intended to be routed directly to the main speakers amplifiers and controlled by the same volume control.

### DETAILED DESCRIPTION

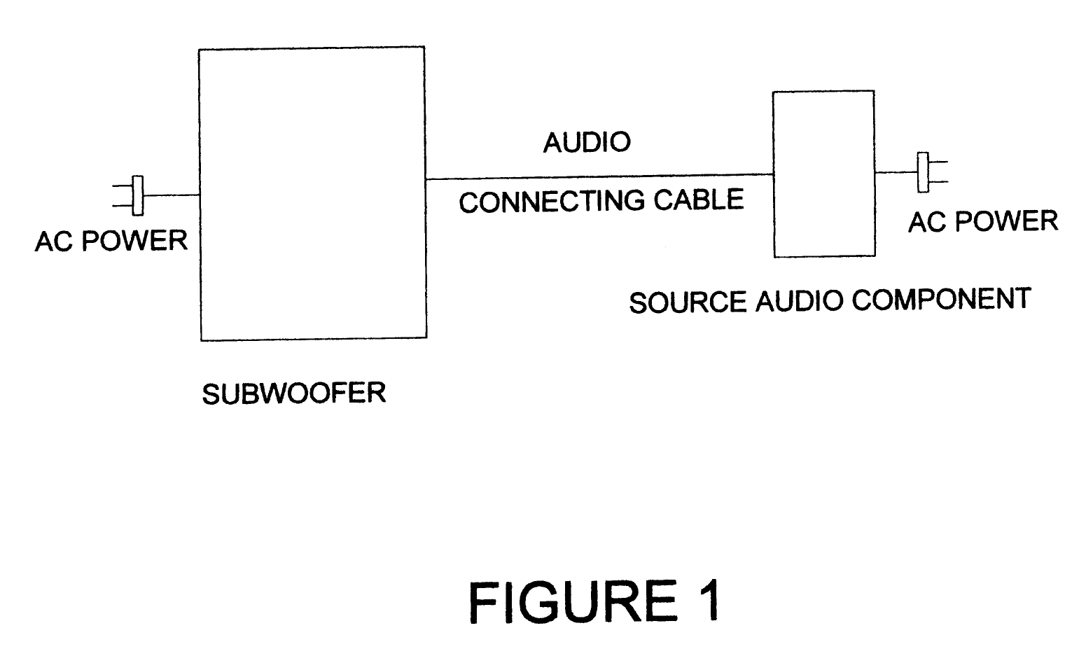

This application applies to the wireless addition of the subwoofer to the typical home audio system, home theater, computer, automobile or commercial sound system FIG. 1 It can also be applied when it is desired to transmit very low frequencies only to a location within a short distance using low power RF with high reliability. These frequencies will typically be in the range of 10 Hz to 250 Hz. Low power FM transmitters have become abundant and inexpensive and although most are aligned for the broadcast band the usage of this type of transmitter receiver system is ideal for this invention. Extremely narrow bandwidths can be employed for the extremely low frequencies transmitted typically no greater than 250 Hz, which is almost one tenth the typical, transmitted audio bandwidth. Greater low frequency modulation levels or narrower bandwidths are gained with the proposed system and there is virtually no possibility of hearing audible high frequency noise components.

The subwoofer is a speaker intended for operation at very low frequencies and is generally placed somewhere in a room where there are associated speakers producing bass, middle, and high frequencies. This means that a subwoofer will be located in close proximity to the source of the audio and the speakers producing the remainder of the sound. The subwoofer or subwoofers may be placed in any part of the room that provides effective bass sound coverage or in a location chosen for visual concealment. Most subwoofers are active in they have a built amplifier that eliminates the need to draw power directly from the amplifier. The active subwoofer only needs to draw power from the AC mains allowing it to also power its' embedded RF receiver while the associated transmitter would also share the power of its' host component.

The recent proliferation of wall mounted televisions, stereo components and speakers make wireless transmission of the low frequencies a necessity since the subwoofer may be located in any part of the room and even hidden from view. This is possible because of the non-directional radiation of low frequencies and the effects of the rooms' acoustics on the sound. The physical location of the more recent plasma screen television is on a wall with no visible wiring showing. The speakers, being physically attached, do not show wires and only connections to the antenna/cable and AC power is arranged locally behind the television. There are even systems to create virtual-acoustic sound images that completely surround the listener using only the front two speakers. In order to add the subwoofer for improved performance with current art a wire must be run to the location of the subwoofer to provide signal. This also holds true for the wall mounted stereo system that needs augmentation by very low frequencies for true full range sound. Typically connecting a subwoofer requires running wires through ceilings, wall or under carpet to facilitate proper placement. It is also possible to utilize an available general-purpose wireless audio links for this purpose but this approach does focus on maximizing the performance and complicates the connections and physical positioning of extra components. This general purpose approach generally requires excessive costs due to extra unnecessary features, extra housings and low volume production. Optimizing the signals and making connections would always confuse the typical consumer

This application applies to powered subwoofers when the amplifier or amplifier/crossover is built into the subwoofer or a separate amplifier is used with a passive subwoofer system. It is well known in the art to transmit audio using radio frequencies or other transmission mediums for a carrier. This application however is restricted to private low power broadcasting where normal application of this restricted medium would result in unreliable reception of the transmitted information. It is within this limited range, restricted by most governments to unreliable consumer applications where this application finds the most merit. It is the purpose of this application to focus the generally inexpensive unreliable low power radio links to a useful reliable application standard for subwoofer connectivity.

One main reason for using full range RF transmission of audio frequencies in the consumer environment is for remote speakers and wireless microphones both wide bandwidth applications. Typically low power RF transmission of audio signals is not preferred because of the high level of noise and possible interference. To overcome these limitations expensive electronics are employed causing the price to overshadow the application for other than specific professional purposes. The preferred embodiment has a main purpose of providing a high quality delivery of the low frequency high fidelity component using any available type of low power RF link preferably FM. Normally in an application involving high fidelity audio signals the preferred transmission method is that of a direct wire connection using a wire type suitable for the purpose. Any link other than a direct wire connection would be less than 100% reliable although the wire does have a small failure margin. Typically the system basics of a RF communication system to communicate a high fidelity signal from one location to another would be one of high performance. However when using restricted cost low power RF communications the resources at hand are low transmitted power, relatively small transmission bandwidth and a low complexity system all required for legal commercial success. The available resources for full range high fidelity audio transmission are contradictory however they are the ideal resources to reliably communicate conditioned audio to possibly the most important component of the high-fidelity system to the subwoofer. In essence the reliable wireless transmission of the sub low frequency component of a high fidelity audio system will ease access to the desirable location for this placement sensitive component therefore increasing its' functionality and performance in the field.

Infrared (light) might be used as a transmission medium however it is limited to line of sight and restricts placement of the subwoofer. It is included as a method of wireless transmission but is not preferred for the subject application. This application applies to wireless analog or digital transmission of low frequencies to the subwoofer from embedded audio sources. Analog transmission is inexpensive and perfectly suited for this application where it is the intention to locate the transmitter and receiver in the same room. Even in areas remote from the main stereo where speakers are located the transmitter can be embedded into the volume control component and operate using the speaker or line level signal from that room to transmit the low frequency information to the otherwise isolated subwoofer. The subwoofer can then be located at the desired location within the room connected only to AC power. The same volume control operating the remote speakers then controls the volume of the subwoofer. The embedded source would be the typical wall mounted volume control wherein the small RF transmitter can be powered through the associated wiring or battery and internally wired to eliminate any need to connect the audio. The intended range of operation for a device of this application would be from 10 Hz to 250 Hz. The range of frequencies associated with hearing is 20 Hz to 20 kHz. This means that we are able to hear frequencies in this range if we are average. The full audio range is easy to reproduce with the exception of the very lowest tones below 40 Hz. There are real physical reasons for this and this prevents the main speakers from being capable of reproducing the bottom octave of sound. Another reason for not including the bottom octaves with the main speakers is the nature of the radiation patterns meaning that optimum physical placement for the low frequency system will not be the same as that for the full range speaker.

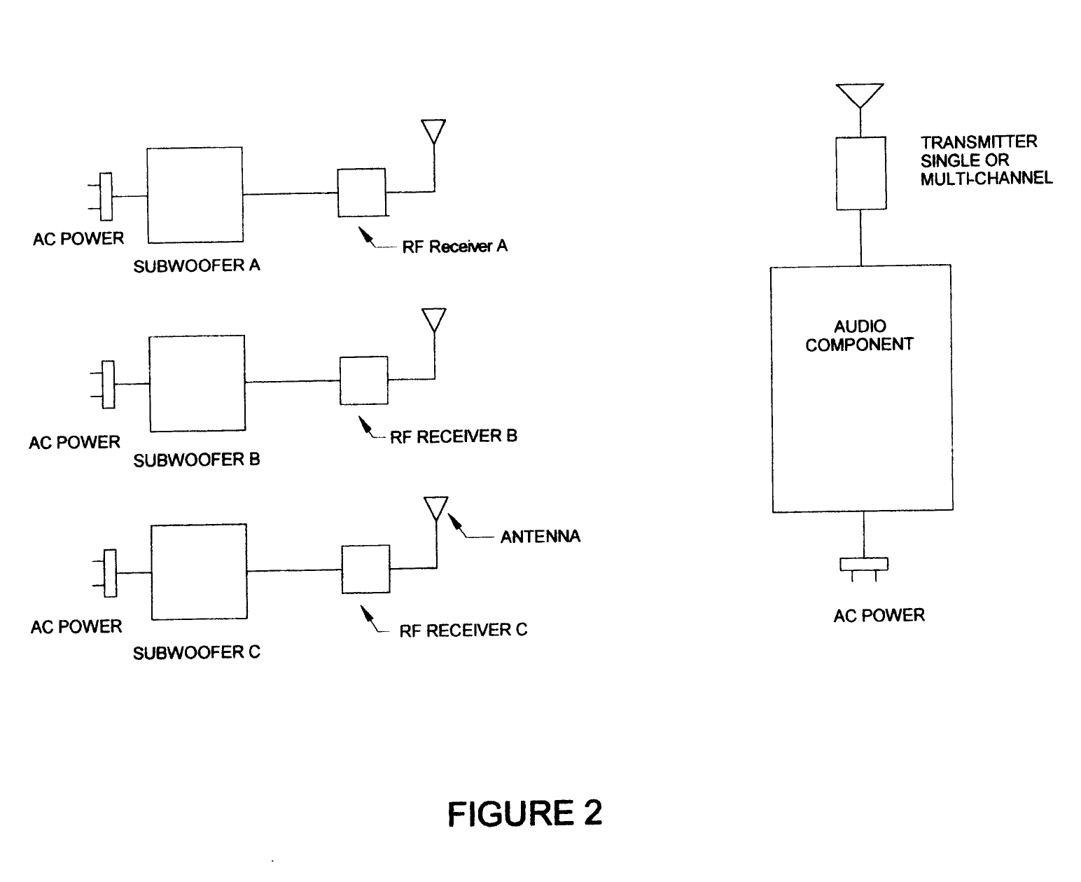

The intention is to allow the flexibility of placement in any location where there might be normal AC power outlets or other source of power and eliminate the need to connect the subwoofer to the sound source directly with a wire. The use of a wireless system also allows multiple subwoofers to be connected to one channel and placed where they might be more effective in the room FIG. 2. This can also be a distribution system where multiple low bandwidth channels are used to provide independent bass signals such as to each home theater speaker location FIG. 2. The use of a wireless subwoofer system can also be an advantage in commercial portable applications when it is easy to embed a transmitter and locate the subwoofer quickly and effectively. The use of radio frequencies is preferred so as to allow visual concealment of the subwoofer/amplifier. Normally radio frequencies are sensitive to the distance of separation of the transmitter and receiver. Wall partitions attenuate RF unpredictably meaning that low power specifications are only reliable when there are no partitions separating the transmitter and receiver. The need to hear the high frequency information at a distance makes this type of apparatus a novelty at best, as most noise components exist at the most audible frequencies.

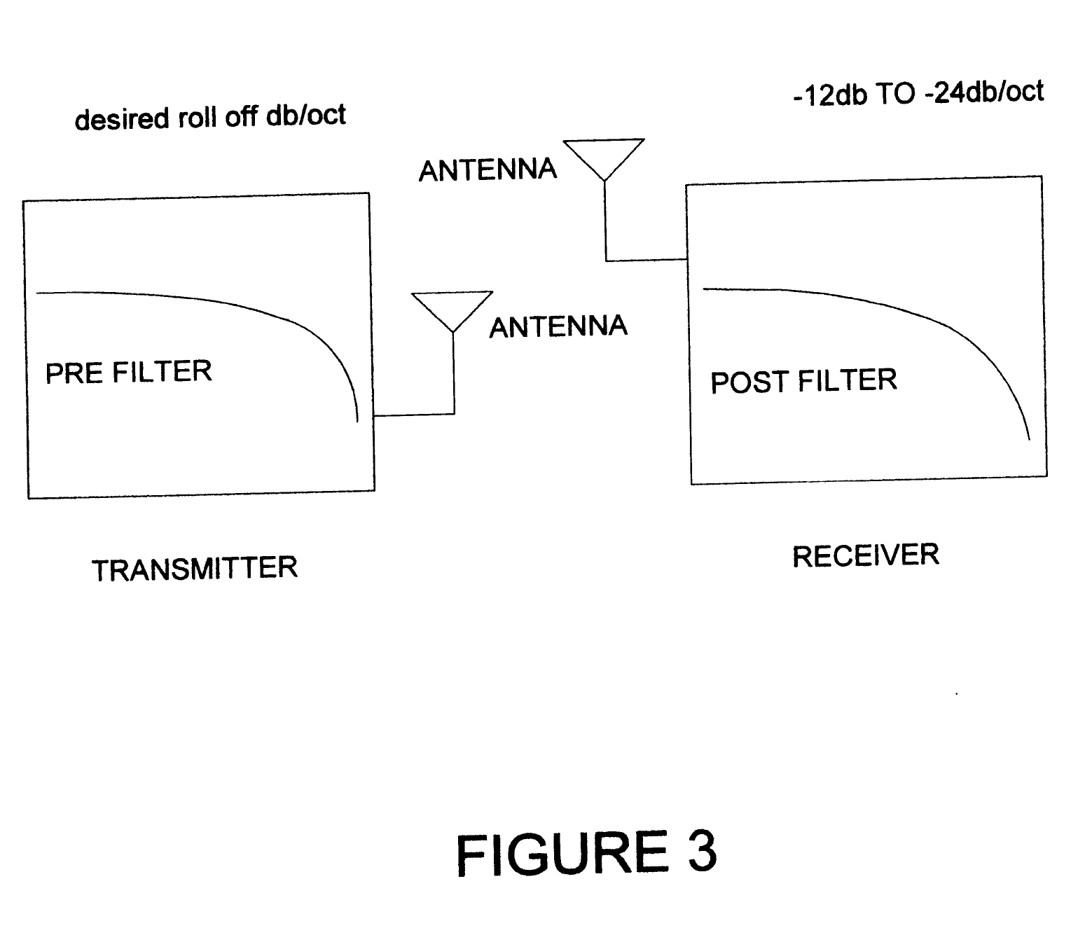

The use of RF to transmit only very low frequencies a very short distance improves the signal to noise ratio as the use of a low pass filter at the output of the receiver demodulator cause an inherent improvement in the signal to noise ratio FIG. 3. The fact that low frequency transmission only is required allows a pre-low pass filter FIG. 3 be included in the transmitter to minimize the potential of over-modulation by higher frequencies. This means that the carrier wave will be modulated only by the lower frequencies further improving the signal to noise ratio and reliability of operation. With FM transmission the total deviation from center carrier frequency is determined by the total frequency content at any given time. If only low frequencies are transmitted then all of the available deviation is available for a very narrow band of frequencies improving the available dynamic range for those low frequencies. This also holds true for amplitude and digital modulation. FM noise rejection is more favorable at low modulating frequencies than at high frequencies making the most popular modulation scheme even more desirable for sub bass frequency transmission. Digital transmission of this narrow band of frequencies causes excessive cost vs. performance gained. This means there are no performance gains in signal to noise or fidelity using digital encoding for this short range application of low frequency audio RF transmission.

Amplitude modulation is even more sensitive to noise interference yet even this modulation scheme is useful for this narrow band of frequencies for all but the harshest interference conditions. Less power is required to provide for the improved signal S/N ratio allowing for more interference free use even in high-density areas. Multiple carrier frequency choices allow for trouble free operation in high-density areas whether manually or automatically selected. There are many available frequencies allowed by governments for usage but the limited power has no inherent advantage for any useful applications. Amplitude modulation could prove advantageous in some limited applications while reliably performing the transfer of the sub-bass frequencies to the subwoofer.

The receiver will include a fixed or adjustable low pass filter to allow for optimizing the audio crossover frequency to match with the associated speakers and location of the subwoofer. Control of this filter can be from the source receiver via of low grade data transmission or locally at the subwoofer. This low pass crossover is typically restricted to pass only frequencies below 200 Hz and provide near infinite attenuation as the frequencies progress to a higher range. Low grade data can be extracted prior to this inherent filtering operation. Typically the rate of the slope of the crossover is 12 db/oct to 24 db/oct or 24 db at 200 Hz (24 db/oct) with increasing attenuation as the frequency progresses higher. As most audible noise arising from radio frequency transmission is at higher audio frequencies this low frequency application also allows for more reliable and noise free transmission as the subwoofer and amplifier remain close to the transmitter and typically within the same walls. For economy a lower cost transmitter can be used with a restricted high frequency range, nominal power and requiring only monaural operation. The very low frequencies of a stereo system are combined and sent to the subwoofer as a mono signal thus eliminating costly multiplexing and de-multiplexing circuitry. If batteries or alternate power source is used a totally wireless transmission system is possible.

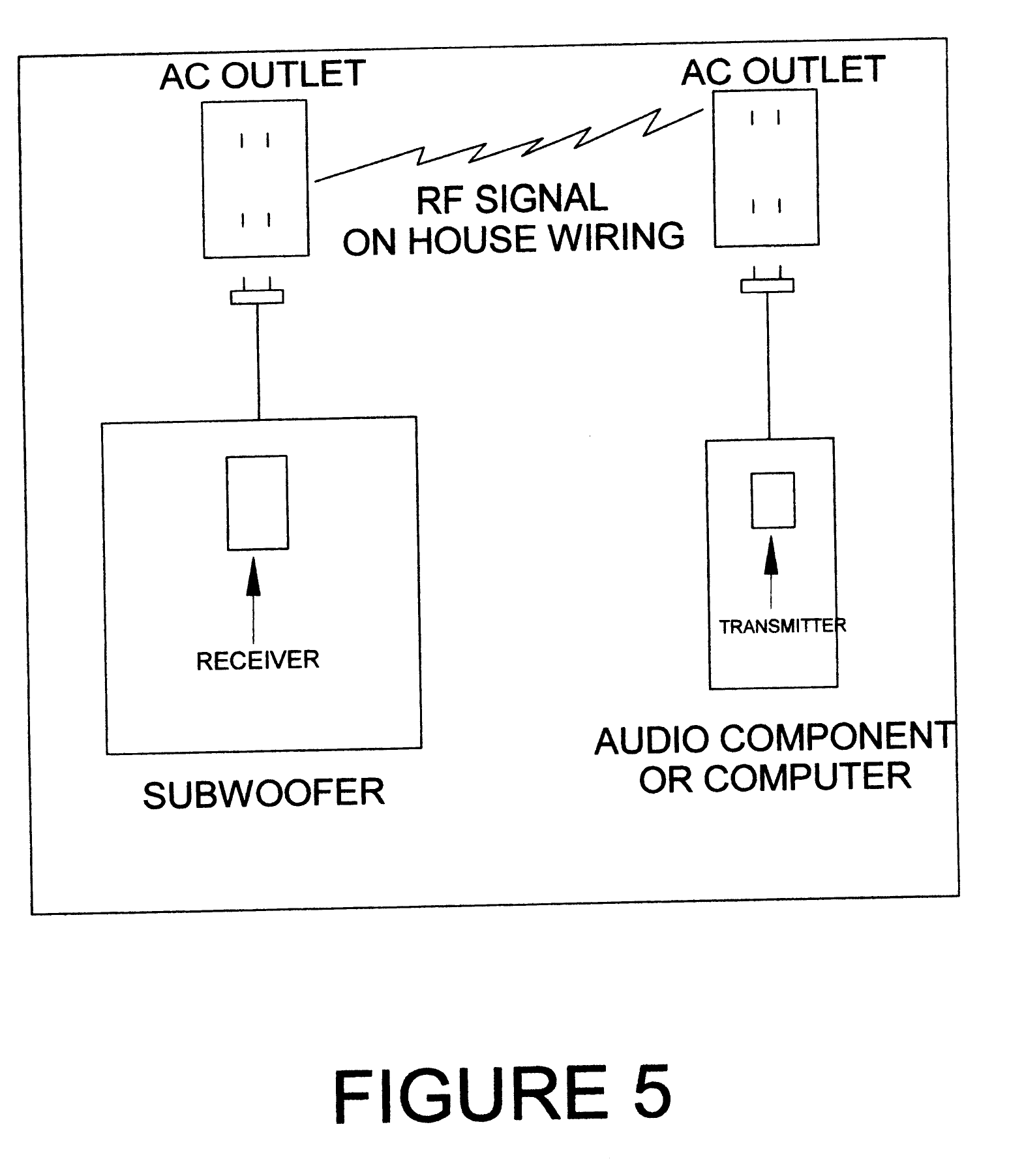

Normally AC outlets are plentiful in a room making totally wireless operation unnecessary in most instances. Another method of RF transmission called carrier current can also be used in which the RF signal is directly multiplexed on to the AC power line FIG. 5. Normally this method requires extensive circuitry design to reduce power line noise for audio transmission but again the inherent filtering of the higher frequencies by the receiver allows for more noise to be present while not affecting the quality of the low bass frequencies. This method requires that you only plug the subwoofer into the outlet intended for power and no antenna is required. Multiple subwoofers can be accommodated for single or multiple channels using multiplexing techniques on the power line. With only very low frequencies being transmitted the RF bandwidth can be narrow for a single channel or include many different channels without an appreciable bandwidth increase. The presence of the carrier signal in its' simplest form can also be used to activate the subwoofer power for always-ready use. The subwoofer power is on whenever the source component or transmitter is active when the RF carrier component activated by the main component is activated. This feature eliminates power waste by activating the subwoofer only when the source component and transmitter are on. Presently the sense of audio signal generally activates the powered subwoofer. The subwoofer is actively on standby as connected in FIG. 1 when the subwoofer senses sound it indicates with a light and passes sound. This causes annoying delays and some times no activation due to level thresholds not being met. The current use of the incoming signal for this purpose causes a needless delay in hearing the low frequency sound. In come cases extremely low levels fail to activate the subwoofer and the subwoofer amplifier always has the main voltages applied.

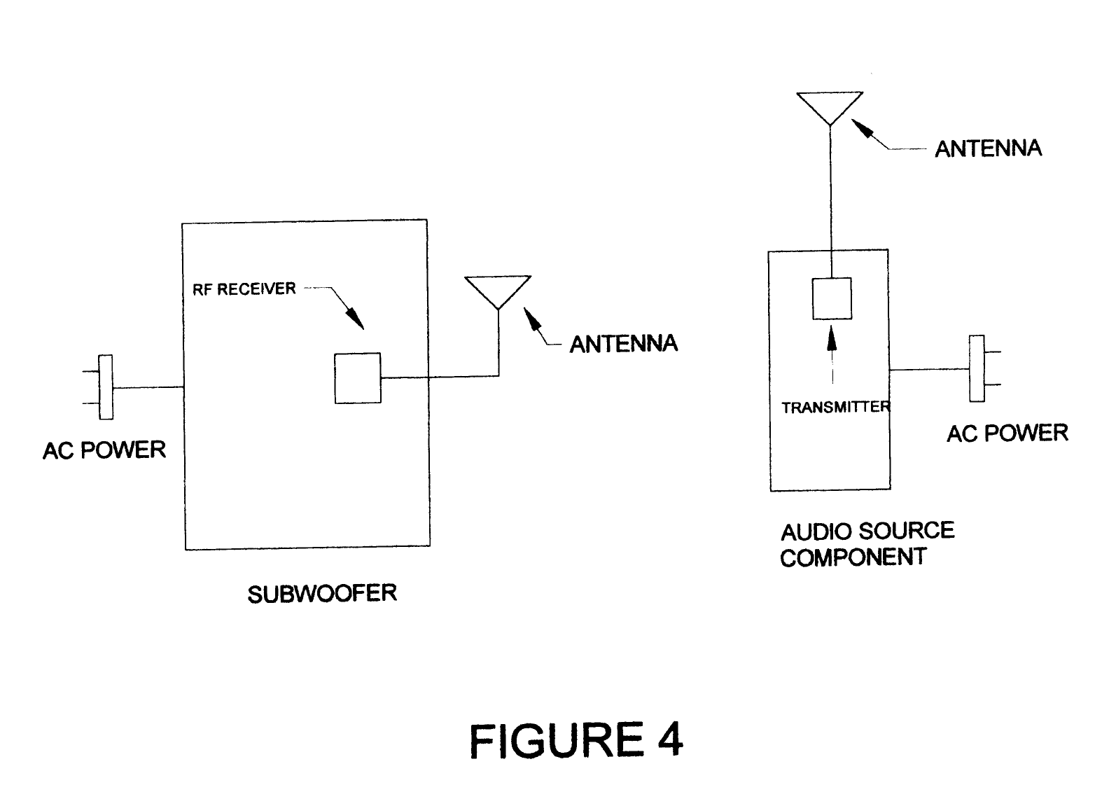

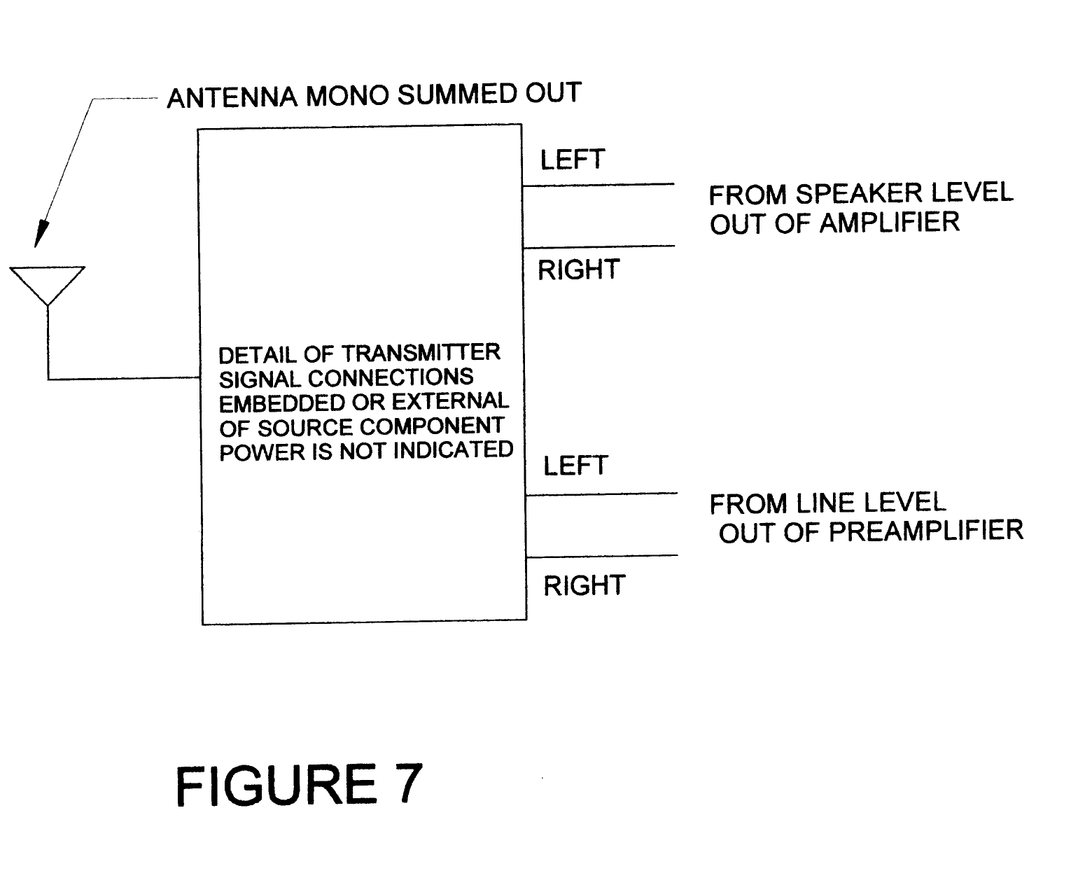

A typical low frequency transmission system would include a transmitter with a low pass filter (typically 6 db/oct) and a receiver with a fixed or variable low pass filter reducing the high frequency information at a 12 db-24 db/oct rate FIG. 3 The receiver is preferably built into the active subwoofer but could be supplied as an external component FIG. 2 jacks to be connected to an existing active subwoofer, amplifier or subwoofer amplifier. The transmitter can be embedded into any device supplying the main speakers with sound using either the speaker level or line level used by the device. The transmitter may include a manual or automatic level control to prevent over-modulation. The transmitter will typically be equipped with input facilities for speaker level outputs or inputs facilities for a line level signal output FIG. 7. The transmitter will be integral of a receiver FIG. 4 or other audio component to eliminate all signal connections for setup of the subwoofer. The user sets his system up with normal connection procedures connecting both units to their respective power source or using battery power at the subwoofer when airborne RF is used. The subwoofer is then ready to produce the sub-bass frequencies when properly adjusted.

Multimedia computers can operate an embedded transmission channel eliminating the need to connect the subwoofer. The desktop speakers will connect as normal and the subwoofer will be connected to power only. Carrier current or airborne RF can communicate the signal to the subwoofer. A complete standard can be organized causing an allegiance among manufacturers to provide a low frequency wireless transmission system within their components to simplify the subwoofer setup for their customers. This will be accompanied by normal wired connection facilities to be used if desired or necessary such as in demonstration rooms. A dual operation communication system can operate automatically with wired overriding wireless when a direct connection to the component is established.

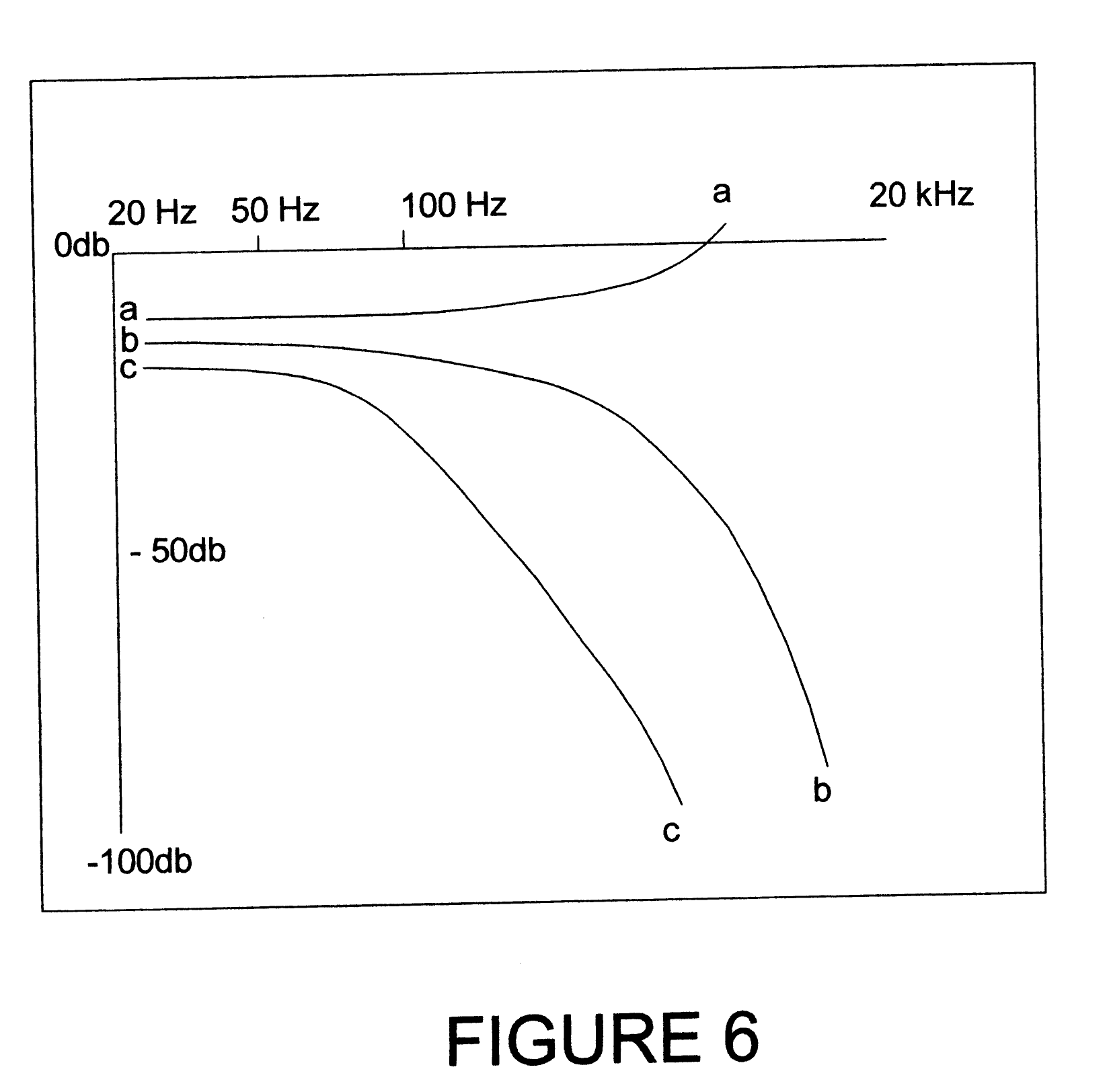

The inherent filtering of low frequencies that occurs when the high frequencies are attenuated beyond the crossover point at a predetermined rate by the receiver reduce noise levels at the subwoofer driver terminals while the subwoofer driver has an inherently limited high frequency response. This combination of filtering allows for a much reduced noise level and near hard wired performance using standard AM or FM modulation. The normal RF noise becomes a minor portion of overall noise content present at the acoustical output of the subwoofer system. The theoretical noise floor at 3200 Hz would be an astounding 123 db with a 24 db slope and 63 db with a 12 db slope. FIG. 6 Curve a represents a typical noise component increasing with frequency as would be expected using this restricted medium for long rang transmission. Curve c represents the slope of the filter inherent in creating a subwoofer only low pass filter intended to both match the crossover frequency while filtering any potential higher frequency noise components from audibility. Curve b represents the resultant curve that might be heard through the subwoofer speaker. This is not taking into consideration the noise floor of the transmission medium, which can vary considerably without affecting the low frequency signal. Low frequency noise is more a function of proper grounding techniques at the transmitter to minimize 50 Hz or 60 Hz AC supply hum and does not play an important part in transmission schemes to have a reasonable S/N ratio. The human ear is also less sensitive to low-level low frequency noise further improving the perceived S/N ratio. The pre and post operations described within are not described in detail as a focused effort to maximum transmission qualities has not been implemented to this date. This dedicated use of low power unsophisticated simple RF modulation techniques make the subwoofer category an ideal candidate for wide scale wireless connectivity without incurring additional costs. A long high quality cable can easily exceed the cost of both the embedded transmitter and receiver. The wireless subwoofer will be a new product category with more simplicity, reliability and functionality.

1. I claim the application of embedded RF transmission and reception electronics to be located in the source audio component and associated subwoofer component. Said electronics designed primarily to provide enhanced wireless transmission and reception for the sub-bass frequencies using low power RF. Herein called signals that can include limited data exchange.

2. I claim the wireless transmission system of claim 1 whereby the wireless transmission means for communicating the subwoofer signal is through use of airwaves and associated antenna.

3. I claim the wireless transmission system of claim 1 wherein the AC power source is used for communicating the RF signal from the audio source component to the subwoofer. The RF is multiplexed on the line in a process commonly called carrier current transmission requiring no additional antenna.

4. I claim the wireless transmission system of claim 3 wherein other inherent dedicated wiring systems of existing structures are used to communicate the signals from the source component to the subwoofer.

5. I claim the wireless transmission system of claim 1 wherein multiple sub bass channels are multiplexed on a single carrier and de-multiplexed at multiple subwoofer locations.

6. I claim the wireless transmission system of claim 1 the use of the RF signal only or multiplexed data to activate power or perform filter, level or other adjustments of the subwoofer or multiple subwoofers.

7. I claim the wireless transmission system of claim 1 whereby a direct-wired connection will cause deactivation of the wireless system with no user interface. When the direct connection is removed the wireless system activates and maintains the signal path invisibly.
